(19) United States
(12) Patent Application Publication
(10) Pub. No.: US 2013/0117261 A1
(43) Pub. Date: May 9, 2013

(54) Context Sensitive Transient Connections

(71) Applicant: Hemanth Sambrani, Bangalore (IN)

(72) Inventor: Hemanth Sambrani, Bangalore (IN)

(73) Assignee: Yahoo! Inc., Sunnyvale, CA (US)

(21) Appl. No.: 13/293,111

(22) Filed: Nov. 9, 2011

(51) Int. Cl. G06F 17/30

(52) U.S. Cl. 707/734; 707/E17.107; 707/E17.014; 707/E17.044

(57) ABSTRACT

Methods, system and computer readable medium for allowing user interaction to an article on an Internet property includes detecting a selection of the article for viewing, by a user. Comments and interactions for the article provided by one or more posters are retrieved, wherein the posters are independent contributors that are not related to the user. A select subset of the comments/interactions for the article are presented to the user in an ordered list based on an association strength between the user and each of the posters related to the subset of the comments/interactions. Interaction, by the user, with a comment/interaction provided by a poster, is monitored and the association strength between the user and the relevant poster is updated based on the interaction. The updated association strength is used to adjust ranking of the comments/interactions for presenting to the user during subsequent selection.

### BACKGROUND

1. Field of the Invention

The present invention relates to social interaction, and more particularly, to generating an organized group of users based on implicit following for social interaction.

2. Description of the Related Art

The meteoric rise in the content on the Internet has lead to creation of various applications to not only monitor and manage the online content but also to enable user interaction. One such application is the message board application wherein a content provider provides content on a web site and allows online exchange of information between people about particular topics presented on the web site. The message board, also termed “internet forum” or “discussion board”, allows users to exchange ideas, thoughts, etc., related to the content by enabling the users to hold conversations through posted messages. The posted messages may be in any form, such as text, images, videos, downloads and/or links.

Some of the content provided by content providers, such as news, tend to attract a huge following in the respective forum, with some news article sometimes attracting over 100,000 messages to an article. When a new user accesses such news articles, the user is overwhelmed with the sheer volume of the posted messages. The vast number of messages is not organized in any specific order, thereby severely restricting the user in identifying relevant comments or holding meaningful conversations with relevant users in the forum. The huge volume of posted messages creates a lot of noise due to a large number of users constantly “chattering” about the article that the user is unable to determine what is going on. When the user accesses the article, the user is presented with comments posted by random posters that the user is not familiar with, thereby restricting the user's activity in the Internet forum and preventing the user from interacting with known or familiar users. This leads to lot of frustration and less than satisfactory user experience.

Some social networks try to overcome this problem by allowing the users to interact within their social circle. In order to interact within their own social circle, the user has to first identify who they want to interact with, “friend” them and then start interacting with them through their own internal message boards or “walls”. This type of interaction is termed “socially relevant” interaction. However, there are drawbacks to this type of interaction. For one, the interaction is restricted to a select set of users that the user is familiar with and whose viewpoints are similar to the user's own viewpoint or known to the user, severely limiting the user's exposure to specific view points for an article. In another social network, a user is able to follow a specific poster's comments/viewpoints by explicitly “following” the specific poster's postings. This type of interaction is similar to the socially relevant interaction mentioned above and has its own drawbacks. For instance, the user needs to specifically identify which poster to follow and then explicitly follow the corresponding poster's comments.

It would, therefore, be advantageous for finding ways to identify a diverse group of users' viewpoints on a particular article to a user so as to enrich the user's viewing experience and encourage the user to interact with these users.

It is in this context that the embodiments of the invention arise.

### SUMMARY

Embodiments of the present invention describe methods, systems and computer readable medium that allow user interaction to an article presented on a property, such as an internet property (i.e., a website, etc.), by identifying a subset of comments/interactions to the article that are relevant to the user. An algorithm is defined that enables selecting a subset of comments and interactions from different users that either has interactive relevance to the user or whose comments are relevant to an article the user is interested in viewing. The select subset of comments and interactions are presented to the user during subsequent viewing of the article so that the user can interact with these comments and interactions in a meaningful way. The algorithm relies on implicit following by identifying comments and interactions that have interactive relevance to the user. Implicit following is identified by tracking the user's interactions with other posters' comments/interactions in the forum related to the article and using this information to filter the large amount of comments/interactions to generate a more focused set of comments that the user can relate to and engage in interaction, making this an useful, efficient and effective filtering tool.

It should be appreciated that the present invention can be implemented in numerous ways, such as, methods, systems and an apparatus. Several inventive embodiments of the present invention are described below.

In one embodiment, a method for allowing user interaction to an article on an Internet property is disclosed. Internet property, as disclosed in this application, is a property owned and operated by a content provider with content for the Internet property provided by the content provider. The Internet property (or simply “property”) can be a website providing information related to one or more articles, a widget providing information related to an article, etc. The method includes detecting a selection of the article for viewing, by a user. One or more comments and interactions provided by one or more posters for the article are retrieved. The posters are independent contributors that are not related to the user. A select subset of the comments and interactions for the article are presented to the user in an ordered list based on an association strength associated with the one or more posters related to the select subset of the comments/interactions. Interaction, by the user, with at least one comment or interaction provided by a poster is monitored and the association strength between the user and the relevant poster is updated based on the interaction. The updating of the association strength is used in adjusting ranking of the one or more comments and interactions for presenting to the user during subsequent selection.

In another embodiment, a method for allowing user interaction to an article on an internet property is disclosed. The method includes detecting a selection of the article for viewing by a user. One or more comments and interactions for the article provided by one or more posters that have previously interacted with the user are identified, wherein the posters are independent contributors that are not related to the user. The interactions between the poster and the user are direct interactions. A select subset of the comments and interactions of the one or more posters for the article are presented to the user in an ordered list based on an association strength between each of the one or more posters and the user. Interactions by the user with a comment or interaction of a poster are monitored and the association strength between the user and the poster is updated based on the interaction. The updating of the association strength is used in adjusting ranking of the one or more comments and interactions of the posters presented to the user during subsequent selection.

In yet another embodiment, a method for allowing user interaction to an article on an internet property is disclosed. The method includes detecting a selection of the article for viewing by a user. One or more comments and interactions for the article provided by one or more posters are identified, wherein the posters are independent contributors that are not related to the user. The comments and interactions for the article are presented to the user in an ordered list based on an association strength of each of the one or more posters. Interaction by the user with a comment or an interaction of a poster presented in the ordered list is monitored and a directed graph with a directed edge connecting the user and the poster is generated when the monitored interaction by the user is a positive type of interaction. The directed edge defines an association strength between the user and the poster based on the monitored interaction. The directed graph is used in identifying interactions for the user during subsequent selection of the article.

In another embodiment, a system for allowing user interaction to an article on an internet property is disclosed. The system includes a client equipped with an user interface for receiving a user selection of the article, transmitting the user selection and for presenting one or more comments and interactions from a plurality of users related to the article. The system includes a server equipped with, (a) a communication interface to receive user selection of the article from the client and to transmit a select subset of comments and interactions from one or more posters in response to the user selection, (b) a memory module to store comments and interactions from the one or more posters, and (c) a processor equipped with an algorithm that is configured to, detect a selection of the article for viewing by the user; identify one or more comments and interactions for the article provided by the one or more posters, wherein the posters are independent contributors that are not related to the user; rank the comments and interactions for the article to the user into an ordered list based on an association strength of each of the one or more posters; transmit a select subset of the comments and interactions in the ordered list to the client in response to the selection of the article by the user; monitor interactions by the user with one or more comments or interactions of one or more posters presented in the ordered list; and generate a directed graph with directed edges connecting the user and each of the posters when the monitored interactions by the user are positive type of interactions, the directed edges defining association strength between the user and each of the posters based on the interactions, the directed graph used in identifying interactions for the user during subsequent selection of the article.

In yet another embodiment, a non-transitory computer readable medium equipped with an algorithm, which when executed by a server of a computer is configured to allow user interaction to an article on an internet property algorithm, is disclosed. The algorithm includes programming logic for detecting a selection of the article for viewing by a user; programming logic for retrieving one or more comments and interactions provided by one or more posters for the article, wherein the posters are independent contributors that are not related to the user; programming logic for presenting a select subset of the comments and interactions for the article to the user in an ordered list based on an association strength associated with the one or more posters; programming logic for monitoring interaction by the user with at least one comment or interaction provided by a poster; and programming logic for updating the association strength between the user and the poster based on the interaction, wherein the updating is used in adjusting ranking of the one or more comments and interactions presented to the user during subsequent selection.

Thus, the embodiments of the invention provide an effective and efficient tool that relies on interactive relevance of the comment/interactions of various posters for identifying and presenting a subset of the comments and interactions for an article to a user. User's interactions with the presented subset of the comments and interactions are monitored. The user's interaction identifies the relevance of the comments and interactions of the various posters presented in the ordered list, to the user. This information is used in updating the association strength of specific posters whose comments and interactions the user interacted with so that subsequent presentation to the user can include the relevant comments and interactions of the posters based on the respective poster's association strength in relation to the user. By focusing on the user's implicit behavior with the various comments and interactions, the algorithm is able to identify and present a focused subset of comments and interactions by a select group of posters so that the user can have an insightful and useful interaction with the select group of posters. The algorithm is able to provide manageable number of posters' comments and interactions to the user so as to allow the user to have meaningful interaction while ensuring that the user is exposed to sufficient variety of viewpoints from different posters. Such focused delivery of the most relevant comments and interactions is sufficient to pique the user's interest thereby enabling a meaningful and satisfactory user experience. The satisfactory user experience can be exploited to increase the monetization at the social network by targeting promotional media content that is relevant to the user's interest.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings.

FIG. 1 illustrates a simplified overview of a system equipped with an algorithm including various modules within the algorithm for allowing user interaction on an article of an internet property, in one embodiment of the invention.

FIG. 2 illustrates a simplified directed graph used in identifying comments and interactions of posters, in one embodiment of the invention.

FIG. 3 illustrates a directed graph that is generated during online interaction between the user and one or more posters, in one embodiment of the invention.

FIG. 4 illustrates a flow chart of various process flow operations used by an algorithm for allowing user interaction on an article of an internet property, in one embodiment of the invention.

FIG. 5 illustrates a flow chart of various process flow operations used by an algorithm for enabling user interaction on an article of an internet property, in an alternate embodiment of the invention.

FIG. 6 illustrates a graph identifying overall interactions between posters that may benefit from the interaction relevance graph of the present invention, in one embodiment of the invention.

### DETAILED DESCRIPTION

Broadly speaking, the embodiments of the present invention provide methods, systems and computer readable medium for allowing a user to interact with a select group of posters that provide comments/interactions on an article presented on a property, such as an internet property, (i.e., a website, etc.), that are most relevant to the user. An algorithm is configured to track interactions between posters and interactions between one or more posters and the user that are relevant to the user or are relevant to an article the user is interested in viewing. A select subset of these comments and interactions are identified, gathered and presented to the user alongside an article the user has selected for viewing. Interactions by the user with the select subset of comments and interactions are tracked. The inference drawn from the interactions between the user and one or more posters is implicit. Information obtained from the implicit interactions is used to filter the large amount of comments/interactions to generate a more focused set of comments that the user can relate to, making the algorithm an useful, efficient and effective tool. The current embodiments tap into a cache of a rich community of users, which may include insightful knowledge from experts in the respective fields, so that the user can experience a rich and diverse interaction for the article.

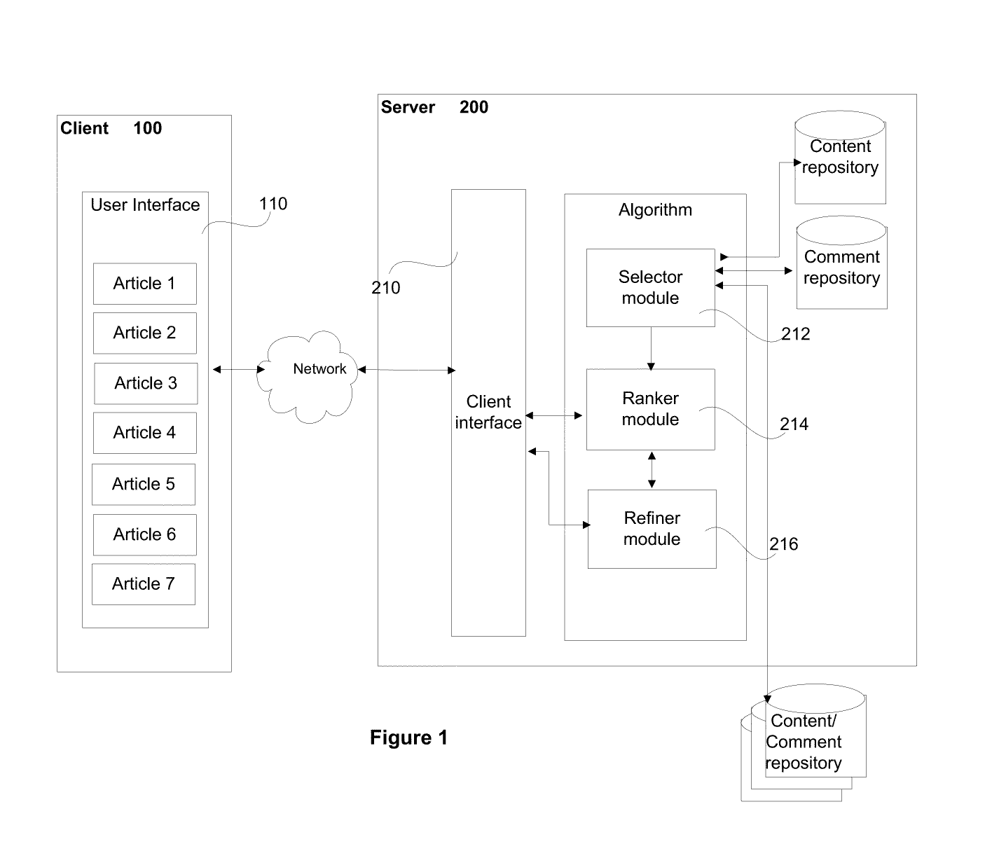

With the brief overview, various embodiments of the invention will now be described in detail with reference to the figures. FIG. 1 illustrates a simplified overview of the system identifying high-level modules that are used to enable a user to interact with a select set of relevant posters for an article on a property, in one embodiment of the invention.

A user begins an online session by selecting an article of content provided on a property at a client 100. The user is connected to a server over a network, such as Internet, either through wired or wireless connection. The server 200 includes a client interface 210 that interacts with the client-side user interface 110 to obtain the selection of the article on a property, such as an Internet property, by the user. An algorithm on the server interfaces with the user interface 210 to obtain the article selection. The algorithm then searches a repository to identify content for the selected article for presentation to the user. The repository may be available within the server 200 or available at an external server 215 but accessible to the algorithm. In one embodiment, the property may be a website provided by a content provider and the article may be a news article. For instance, in a website, such as Yahoo! homepage, the article may be a current News article or a Sports article or an Entertainment article. The algorithm searches a repository to identify content for the selected article. In addition to the content for the selected article, the algorithm may also search an internal or external repository (200 or 215) and identify a plurality of comments/interactions provided for the article by a plurality of posters, for presenting to the user. Thus, for a news article related to Tsunami in Japan, the algorithm identifies all the comments/interactions associated with the selected news article from a plurality of posters for presenting to the user along with content for the selected article. Depending on the popularity of the article, the number of comments and/or interactions may range from a handful to hundreds of thousands.

As a result, the algorithm needs to determine which of the thousands of comments/interactions to select for presenting to the user. The algorithm includes a plurality of modules, such as a selector module 212, a ranker module 214 and a refiner module 216. The selector module identifies which of the comments/interactions associated with the article are relevant to the user. When there are only a few comments/interactions for the article, it is easier to select all of the comments/interactions and present them to the user. However, when there is a large amount of comments/interactions for the article, the selector module identifies and selects a subset of the comments/interactions based on corresponding poster's interaction relevance to the user. The selector module is configured to identify the interaction relevance of the various comments/replies by computing association strengths of each of the posters based on the comments and its relevance to the user.

There are different types of relevancies that can be associated with an article or a poster. Some of the relevancies may include social relevancy, contextual relevancy and interaction relevancy. The above list of relevancies is exemplary and should not be considered limiting. Social relevancy is when a first poster and a second poster have an established social connection. For instance, a first poster posts a comment for an article, such as a healthcare article, and a second poster responds to the comment from the first poster. The response from the second poster may be on a baseball score or death of a bird, which is totally irrelevant to the article or the comment of the first poster. Thus, even though the comment/response by the second poster is irrelevant to the article, the second poster is considered to have a tangential relevance to the first poster based on the social connection between the second poster and the first poster.

A comment posted for an article presented on a property is considered to be contextually relevant when the comment is related to the context or content of the article. Using the same article on healthcare discussed above, a first poster may post a comment on the healthcare bill passing through United States Senate. The comment by the first poster is considered to be contextually relevant to the article as the subject matter of the article and the context of the comment relate to the same subject matter. When a second poster posts a reply to the comment or to the article that is also relevant to the subject matter, then the second comment/reply is considered to be contextually relevant to the article and the second poster is considered to have contextual relevance to the first poster and with the article.

The third type of relevance is interaction relevance. This relevancy is based on interactions between posters that are related to comments posted for an article. In the above example with reference to a healthcare article, a first comment is posted by a first poster for this article. When a second comment or reply is posted by a second poster under the same article in response to the first comment posted by the first poster, the second comment or reply is considered to have an interaction relevance to the first comment by the first poster. In other words, an interaction relevance is established by a second poster based merely on the second poster's expression that a certain piece of content (i.e. first comment) produced by another user (i.e. first poster) is relevant to the second poster by actually interacting with the comment posted by the first poster. The various embodiments of the invention will be described with reference to the interaction relevance to an article on a property.

Still referring to FIG. 1, in order to compute the association strength of each of the posters that provided the comments/replies to the selected article, the selector module first determines various attributes associated with the comments/replies. In one embodiment, the attributes may include poster identifier, direct/indirect interaction, type of comment (for e.g., positive or negative), action (for e.g., thumbs-up/down, like-it/dislike-it, informative, irrelevant, funny, offensive, abusive, pertinent, report of abusive comment/action, etc), accumulated amount of replies to a particular comment, geo-location, temporal attribute (for e.g., date-stamp), etc. The above list of attributes is exemplary and should not be considered restrictive. As a result, other attributes may be considered by the algorithm for computing the association strength of the posters. The selector module then computes the association strength of the poster as a function of the various attributes related to the comment. In one embodiment, a direct interaction between a poster and a user or between two posters will have a higher association strength than a pair of posters/poster and user that have indirect interaction. In one embodiment, an interaction between any two posters/poster and a user is considered direct interaction when the poster/user responds to a comment provided for an article, by a poster.

An indirect interaction is when a third poster responds to a comment, reply or interaction posted by a second poster in response to a comment/reply posted by a first poster. In this case, the interaction between the third poster and the first poster is considered indirect interaction while the interaction between the first and the second poster and second and the third poster are considered direct interactions. The algorithm may compute a degree of intensity of engagement between the posters taking into consideration the relative distance between the posters in the directed graph to determine the association strength of the posters. In one embodiment, the degree of intensity of engagement and, as a result, the association strength between the posters decreases exponentially as the number of indirect level increases.

In one embodiment, in addition to the degree of intensity of engagement, the selector module may base the computation of the association strength on the type of comment. For instance, a positive type of interaction is considered higher than the negative type of interaction. Further, within the positive type of interaction, the selector module may determine the action of the user/poster during computation of the association strength. For instance, in one embodiment, a pertinent information may be weighed heavier than a funny or “like-it” action. Similarly, an abusive comment may be weighed heavier than a dislike comment.

In one embodiment, the selector module may take into consideration both the degree of intensity of engagement and the type of interaction to compute the association strength. For instance, a first poster positively comments on an article. A second poster may comment/reply to the comment of the first poster. However, the second poster may respond negatively to the comment from the first poster. As the association strength relies on the type of interaction, the association strength between the first poster and the second poster is adjusted downward based on the negative posting by the second poster. A third poster may post a comment in response to the second poster's comment disagreeing with the second poster's reply to the first poster's comment. The interaction between the second poster and the third poster is a direct but negative interaction. As a result the association strength between the two is adjusted taking into consideration the direct but negative interaction. In this example, the interaction between the third poster and the first poster is an indirect interaction. Further, since the third poster disagreed with the second poster's comment/reply, the third poster is essentially agreeing with the first poster's comment, making the indirect interaction a positive type of interaction. The selector module will consider all of these aspects of interaction when computing the association strength between the various posters and between the poster and the user. If a fourth poster responds to the second poster's comment agreeing with the second poster, the fourth poster has a direct and positive interaction with the second poster thereby strengthening the association strength of the second and fourth posters. Since the fourth poster agreed with the second poster, the fourth poster also disagrees with the first poster. As a result, the interaction between the fourth poster and the first poster is an indirect and negative interaction. Thus, the association strength between the fourth poster and the second poster will be strengthened due to both a direct interaction and a positive type of interaction whereas the association strength between the first and the fourth posters will be weakened due to the negative type of interaction and will further be exponentially weakened due to the indirect interaction. Along similar lines, the association strength between the third poster and the second poster will be strengthened by the direct interaction but will be weakened by the negative type of interaction whereas the association strength between the third poster and the first poster will be weakened by the indirect interaction but strengthened by the positive type of interaction.

In addition to the above aspects, the computation of the association strength may also consider the number of interactions between the posters and between the posters and the user. Thus, for instance, the selector module may determine the number of comments/interactions exchanged between each pair of posters and between each of the posters and the user and weigh the pair of posters or poster and user with a greater amount of interactions between them higher than the posters that have had less interactions. As can be seen, various aspects of the interaction attributes are considered during computation of the association strength of each poster.

To begin with, upon receiving a selection of an article from a user, the selector module will search all the repositories where all comments/interaction related to the article are stored to determine if there are any interactions between the user and one or more posters of comments for the article, in one embodiment of the invention. If it is determined that there are interactions between the user and each of the posters, the selector module will identify the association strength between the user and the various posters who have interacted with the user and identify a subset of comments/interactions from a select subset of users based on the association strength of the posters.

A ranker module will receive the select subset of comments/interactions and use a ranking algorithm to rank the comments/interactions of various posters who have interacted with the user. In one embodiment, the ranking algorithm may take into account the association strength associated with the posters whose comments/interactions are selected in the subset, to rank and prioritize the comments/interactions. An ordered list of comments/interactions from various posters is generated and returned along with the content of the article for rendering at the client, in response to the selection of the article.

Any interactions with the comments/interactions at the client are monitored and transmitted to the algorithm on the server. A refine module tracks the interactions, interacts with the selector module to retrieve the association strength of the comments/interactions with which the user interacted with and updates the association strength of the respective posters based on the interaction by the users. The association strengths of the posters are adjusted based on the attributes of the interactions with the respective comments/interactions. The adjusted strengths of the posters are used in identifying comments/interactions of various posters for the article during subsequent selection and rendering of the article.

In one embodiment, the algorithm determines if there are any comments/interactions for the article. If there are comments/interactions for the article, the algorithm verifies to see if there are any comments/interactions that were exchanged between the user and the one or more posters of comments/interactions for the article. If there are no comments/interactions between the posters and the user, the selector module of the algorithm, in one embodiment, will identify a select subset of the plurality of posters with high association strengths and identify a subset of comments/interactions from the select subset of users for returning to the client. In another embodiment, the algorithm may select the set of comments/interactions that are most popular, most replied (i.e. number of count of responses to a particular comment), currently being commented on, most recent, the oldest set of comments, the set of comments that the user was previously viewing, etc. The selected comments/interactions are presented to the user alongside the content of the article.

The algorithm then monitors the user's interactions with the presented comments/inter-actions and identifies the various actions of the user provided in each interaction. For instance, the algorithm may identify actions, such as thumbs-up, marking a particular comment as relevant or pertinent, strongly-agree, like-it, thought it was funny, informative, etc. In addition to the various actions, the algorithm may also identify number of replies that has accumulated for a particular comment, profile of a user, etc. The algorithm also looks at the past interaction sessions to determine streams of activities by the user and tracks the user's reply to specific comments/interactions. These specific interactions contribute to positive engagement of the user. On the negative engagement side, the algorithm tracks thumbs-down, a reply that directly responds and insults the user in question on his comment, abusive interaction, inappropriate, and reporting of abusive poster. In one embodiment, the algorithm may determine an interaction is of positive or negative type by relying on the context of the reply provided by the posters and by identifying certain keywords that can be associated with positive or negative type of interaction. Similarly, the algorithm may rely on the context of the reply provided by the user in response to comments/interactions of one or more posters to determine if the reply provided by the user generates a positive or a negative engagement, like/dislike comments, etc. In another embodiment, the algorithm may associate certain actions toward positive engagement and certain other actions toward negative engagement. The algorithm, thus, relies on the primary class of engagement between the user and a poster as the engagement relates to direct interaction between the user and the poster. The algorithm identifies the various interactions and the corresponding association strengths between posters and between the posters and the user through a directed graph.

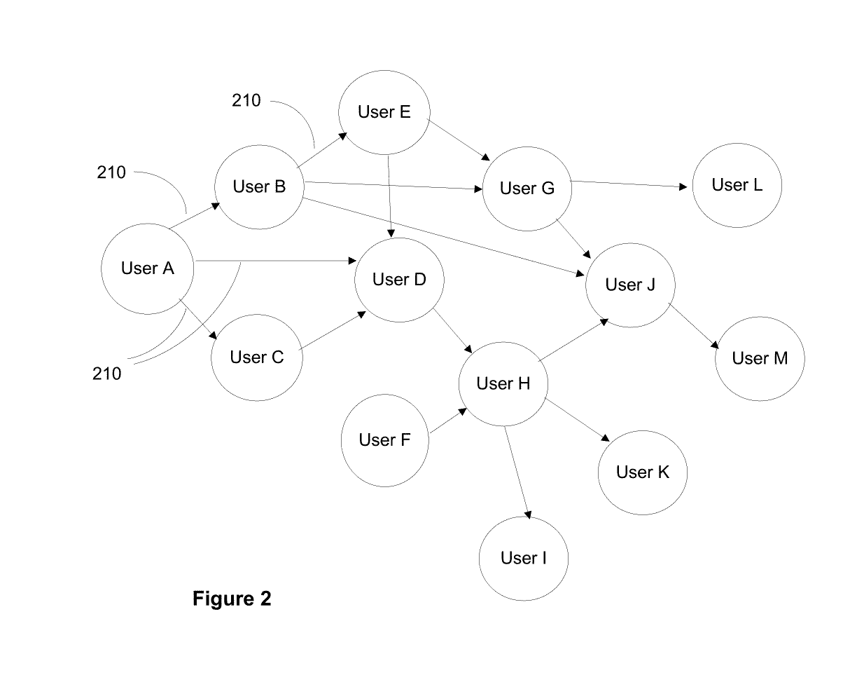

The process of generating, maintaining and analyzing a directed graph for various interactions between posters and between posters and the user will now be described with reference to FIG. 2. The algorithm generates a directed graph by tracking interactions between any two posters or between a poster and a user. As illustrated in FIG. 2, the directed graph includes a set of nodes with edges connecting any two nodes. Each user is represented by a node and an edge between a pair of nodes indicates an interaction-based association between the users represented by the pair of nodes. The type and intensity of interaction is captured by a weight associated with each edge. Initially, when a user/poster newly joins an online forum associated with an Internet property, the user/poster will not have any directed graph associated with him, i.e. will not have any edge connecting the node representing the user to any other nodes in the overall directed graph. As and when the user/poster starts interacting with other posters comments/interactions, a directed edge is formed between the posters or between the user and the poster with whom the user is interacting with, based on the type of interaction. For instance, when the interaction between two posters or between the user and the poster is a positive interaction then an edge is formed between the two posters or between the user and the poster. The association strength between the posters/user and the poster is computed based on the type of positive interaction and is associated with the edge. When a negative interaction is detected between the same two posters or between the user and the poster during subsequent interactions within the same session, the association strength between the two posters or between the user and the poster is adjusted downward based on the type of negative interaction. When the association strength between any two nodes in the directed graph is below a threshold value, the edge between the two nodes may be deleted. Information related to removal of edge is discussed in more detail later. The selector module thus monitors interactions between any two posters or between a poster and a user, determines the type of interaction, determines if an edge connection exists between the two posters/poster and the user and computes the association strength between the two posters/between the poster and the user to reflect the type of interaction.

In one embodiment, different types of actions may be presented to a user/poster in a drop-down box for selection during the interaction session. It should be noted that the types of actions may be provided in any format and that the above embodiment using a drop-down box is exemplary. The association strength between the two posters are dynamically adjusted either up or down by specific levels specified in the algorithm, wherein the levels are dictated by the type of action selected. For instance, the association strength between any two posters may be stronger when the action selected during the interaction is “strongly agree” than when the action selected is “like-it.” Any subsequent interactions between the posters or between the poster and the user are captured by the algorithm and the graph is updated to reflect the interaction by either creating additional edges, if they did not already exist, or updating the association strength between any two posters or between the respective posters and the user, based on the interaction. The various factors of the interaction that affect the association strength or the edge weight of an edge between any two nodes include direct or indirect interaction, a positive or a negative interaction, temporal dependency, geographical dependency, type of action selected, etc., wherein each factor is accorded a certain weight in the computation.

In one embodiment, the computation of the association strength between any two nodes in the directed graph encompasses interactions associated with various articles of the internet property and is not restricted to just one article of the internet property. The articles may all belong to a single category or may belong to different categories. When the association strength is computed by the algorithm, the algorithm takes into consideration any and all interactions between any two posters or between a poster and a user irrespective of which categories the articles belong. In this embodiment, the algorithm may weigh different categories differently during computation of the association strength between any two posters. For instance, interactions related to an article in Finance category may be weighed differently from an article in Sports category or Entertainment category. In another embodiment, the weighing of different categories may depend on the ranking, popularity, reputation or knowledge of the different posters/user in the respective categories. For instance, user A may be an expert in Finance category but may be a novice in Sports category. As a result, any interaction by user A in the Finance category is weighed heavier than the interaction in the Sports category. The algorithm, thus considers the various factors associated with the interaction during computation of the association strength between any two posters.

The following example will provide a better understanding of the generation of the directed graph and computation of the association strength in selecting a subset of interactions for presenting to a user, when the user selects an article for viewing. For instance, user A interacts in a positive manner with poster B regarding a comment poster B posted for an article that user A is currently viewing on an Internet property. User A's interaction to poster B's comments may be a comment or an action. This might be the first interaction between user A and poster B, which is a positive interaction. The algorithm recognizes the interaction and generates a graph with user A and poster B as two nodes and an edge between the two nodes. The edge is a directed edge identifying the direction of the interaction. An edge weight for the edge between user A and poster B reflecting the association strength is computed based on the positive interaction. Along similar lines, when user A interacts in a negative manner with poster B and this is the first interaction between the two, there will be no edge formed between user A and poster B. This is due to the fact that the interaction is not a positive interaction and user A disagrees with poster B's viewpoint and has nothing in common with poster B. It should be noted that an edge is formed/created only when an initial interaction between two posters is a positive interaction. Once an edge is formed between two users' nodes, subsequent interactions between the same two users will result in adjusting the weight of the created edge. Thus, every type of interaction between two users/user and a poster will result in either creating a new edge or adjusting the weight of an existing edge.

Subsequently user A interacts with comments posted by posters C and D, in a positive way. The comments posted by posters C and D may be in the same category as the one posted by user B or may be in a different category. The algorithm detects the positive interactions between user A and users C and D and forms edges between users A and C and between users A and D and the edge strength for these two edges are computed taking into consideration the various factors of the positive interaction including the category.

When user B interacts with user A's comment/interaction, a second directed edge is generated by the algorithm, but this time the edge is directed from user B to user A identifying the direction of the interaction. Additional interactions between users A and B are detected and the corresponding edge strengths are dynamically computed and adjusted either up or down to reflect the nature and type of interaction. In one embodiment, the association strength or the edge weight of an edge may be computed taking into account the interactions between the two posters/poster and the user in various categories available at the internet property and various article within each category. In another embodiment, the directed graph and edges generated between posters may be distinct for each category of the internet property. Irrespective of how the directed graph(s) are generated, the information related to the directed graph is stored in one or more databases. For instance, information related to a directed graph for each internet property or for each category within an internet property may be stored in one or more databases for future retrieval and analysis.

In addition to generating and updating a directed graph to reflect the relative weights of the edges, the algorithm searches the one or more databases to retrieve any and all comments/interactions that a particular user exchanged with other posters for a particular category or for a particular internet property (or simply property) or all comments/interactions of different posters for a particular article/category. A user may select an article, such as a Financial news article, available on the property, such as a Yahoo! news website, for viewing. The algorithm identifies the selected article (i.e. Financial news article), determines a category (i.e. Finance) the article belongs to and retrieves comments/interactions between the user and various posters or between different posters for the article and/or for the category. The interactions in certain categories and in certain properties may exceed 100,000+, depending on the popularity of an article with the internet community. Consequently, the algorithm identifies the comments/interactions that are available in the particular category associated with the article and retrieves a select subset of comments/interactions that are relevant to the user. The select subset of the comments/interactions is put into an ordered list for presenting to the user, in response to the selection of an article, in one embodiment of the invention. In the above example, the algorithm determines that users B, C and D have interacted with user A for a particular category and, as a result, identifies and retrieves any and all comments/interactions associated with the article from users B, C and D and these comments/interactions are ranked higher than the remaining comments/interactions due to the respective user's interaction with user A.

In one embodiment, the algorithm will identify all the comments/interactions from posters that have interacted with the user A irrespective of the category of the article. In this embodiment, the algorithm will rank the comments/interactions related to the article from different posters using a ranking algorithm based on the number of interactions the poster had with the user and generate an ordered list of comments/interactions for presenting to the user. For instance, user A interacts with user B 7 times and with user C 4 times. When the comments/interactions from users B and C are being considered for returning to user A, comments from user B will be ranked higher than the comments from user C due to sheer volume of interactions between the users B and A as compared to the interactions between users C and A. In this example, all interactions between users B and C with user A are positive interactions. In an alternate example, user B interacts with user A 7 times and user C interacts with user A 5 times. The interaction between user B and user A is a mixed interaction with 3 interactions being positive and 4 interactions being negative. The interactions between users C and A are also mixed interactions with 4 interactions being positive and 1 interaction being negative. In this example, the algorithm will select the interactions of user C and rank them higher than the interactions from user B based on the number of positive interactions exchanged between the users. Thus, even though the number of interactions between users B and A are high, the algorithm will sort the number of positive interactions from a specific user higher than the overall number of interactions. In a further embodiment, the positive interactions of user C are ranked higher followed by the positive interactions of user B and the negative interactions of users C and B are presented in the respective order. The generated graph is an interaction relevance graph that associates the various users/posters through their interactions with one another. The generated graph continues to be updated/expanded as and when links through different articles across networks, across properties and across categories are traversed.

As mentioned earlier, the graph captures negative interactions between posters, computes and adjusts the association strength between the posters suitably taking into account the type of negative interaction between posters. The negative interactions between posters, as with the positive interactions, may be directed toward a particular article the user has selected for viewing or may be directed toward a different article within the same category. As with the positive interactions, the degree of association strength intensity between the respective posters will be adjusted by a predetermined amount based on the type of negative interaction. When more and more negative interactions are provided by a particular poster, the association strength between the particular poster and the user keeps diminishing. In one embodiment, once the association strength between the particular poster and the user reaches or drops below a pre-defined threshold value, the association strength defaults to negative infinity. The algorithm recognizes the default and breaks the edge between the two posters indicating that there is absolutely no interaction relevance between the particular poster and the user. The algorithm keeps track of how active a user or poster is in the interaction forum by tracking the size of the graph and also tracks the type of article(s) the user/poster is most active in a positive or a negative manner and adjusts the association strength or the edge weight accordingly. The algorithm uses the edge weight in identifying the comments/interactions for presenting to the user during subsequent request for viewing the article.

During the generation of the directed graph, the algorithm may also take into consideration the various aliases a user/poster has in the interaction forum. For instance, user A may have an alias “Don” in Finance category, alias “X” in Sports category and alias “Y” in Politics category. The algorithm will internally recognize that the various aliases all belong to user A using one or more user attributes associated with the aliases and build the directed graph and compute association strengths taking into account the interactions of the various aliases of user A in different categories. A user's opinion in Sports may not align with the user's opinion in Finance. Thus, in order to ensure that the user's graph provides a proper and complete perspective of the user's varying viewpoints, the categories are accorded appropriate weights during the computation of the association strength between the user and other posters. The mapping between internet properties to various categories and categories themselves make it easy to manage the association strength for categories.

When a new category is defined for an article, relevant comments/interactions for the new category are presented by using the association strengths related to various categories represented within user graph to present relevant comments/interactions to a user. For instance, user A may have interacted with user B in a first category (for e.g., Sports) and had positive interactions while user A may have interacted with user B in a second category (for e.g., Finance) and had mixed or negative interactions. With the overall association strength between user A and user B represented in the directed graph, the algorithm may present more of the positive comments/interactions from user B from the first category at the top by ranking those comments/interactions higher and ignore or selectively rank the comments/interactions from user B in the second category lower based on the negative interactions.

In one embodiment, as mentioned earlier, the positive/negative interactions may be provided by selecting a thumbs-up/down option and selecting a sub-option within the thumbs-up/down option using a drop-down box. For instance, sub-options within a thumbs-up option may include witty, informative, agree, like-it, relevant, etc., and the sub-options within a thumbs-down option may include offensive, abusive, disagree, etc. In an alternate embodiment, instead of providing a drop-down box of options/sub-options, the algorithm may include a set of animated options to provide the same level of interactions as the drop-down option. The animated options for expressing agreements/appreciations or disagreements/distastes provide a more interactive and expressive game-like way of expressing a user's opinion. For instance, the animated options for thumbs-up option may be of varied formats and may include explosion of firecrackers, throwing of confetti, providing applause, animated emoticons with appropriate positive expressions or smiley faces, etc., while options for the thumbs-down option may include throwing rotten tomatoes, throwing rotten eggs, an animated emoticon or frowning face emoticons, etc., wherein the intensity of each action selected by a poster/user from the available options may provide a relative strength of agreement/appreciation or disagreement/distaste that can translate to a relative sentimental value for enhancing or reducing the association strength between two posters.

In one embodiment, when the list of comments/interactions selected by the algorithm is provided to the user, in response to selection of an article on an internet property, the algorithm may insert one or more comments/interactions from a random poster into the ordered list of comments/interactions and present the list of comments/interactions to the user. In this embodiment, the random poster may or may not have interacted with the user and his comments may not be part of the select subset of comments/interactions identified by the algorithm for presentation to the user. The random comment is inserted into the ordered list so as to provide an alternate perspective or viewpoint to the user. Since the algorithm identifies a select subset of comments from posters that have interaction relevance to the user, the user may be exposed to the same set of users that he has been interacting with. In order to expose a reasonable degree of variety in what is being presented and to expose the user to a different viewpoint, the algorithm may periodically select a comment from a random poster and insert the comment randomly in the ordered list so that the user can interact with the comment from the random post. For instance, the comment from the random poster may be presented within the first 5 or 10 posts presented to the user. At this time, the random poster may or may not have any interactive relation established in the user's graph, which indicates that the random poster may have interacted indirectly or may not have interacted with the user at all. The interactions between the random poster and the user are monitored and the directed graph of the user is updated to either include an edge (when no edge is available) between the user and the random poster or updating the edge to reflect the interaction. In one embodiment, the random poster is picked from within the same category as the article selected by the user for viewing. The insertion of comment from a random poster enables striking a balance between an established set of posters that the user interacts with and a new set of users.

The algorithm may provide a way to reduce the number of comments/interactions presented to the user so that the user is able to relate to a manageable set of users and have a meaningful interaction. To accomplish this, the algorithm, in one embodiment, may consider a temporal attribute during selection of comments/interactions from the directed graph. Accordingly, the algorithm may periodically perform a “sweep” of the directed graph to reduce the association strength between the posters and between the poster and the user at each of the edges by a predefined value. This would result in reducing the association strength across all edges thereby preventing the association strength from perpetually increasing. The sweeping operation may result in refining the ordered list of comments/interactions as some of the association strengths may fall below the threshold value resulting in the breakage of one or more edges between one or more sets of posters/user.

FIG. 2 illustrates a simple directed graph established between a user and one or more posters, in one embodiment of the invention. When a user interacts with a poster, a directional edge is established between the user and the poster with the direction of the edge defining the direction of the interaction. As illustrated, when user A interacts with poster B, a directed edge 210 is formed between user A and poster B. Similarly, second and third directed edges 210 are formed between user A and each of posters C and D.

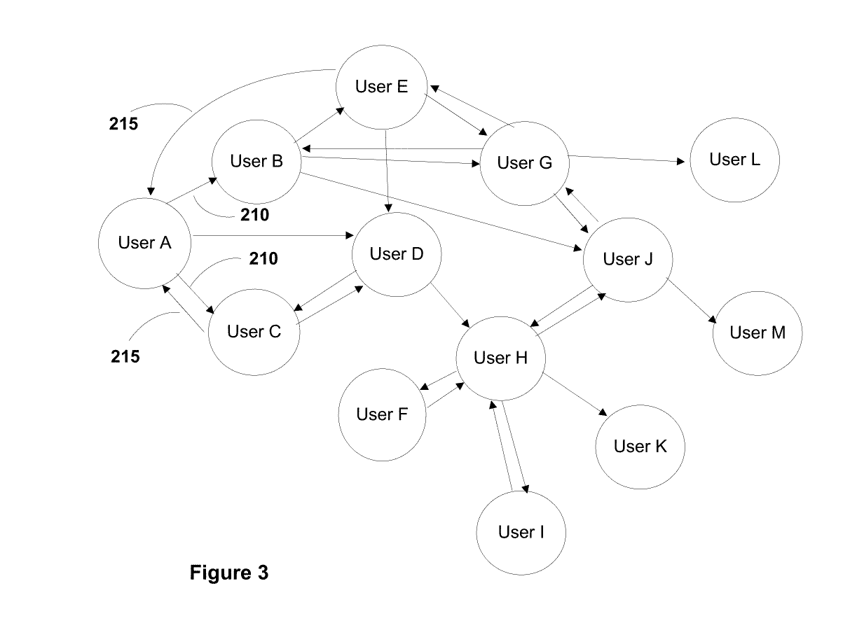

FIG. 3 illustrates a simplified directed graph with bidirectional edges formed between various posters and the user. As mentioned with reference to FIG. 2, a first directional edge 210 is formed when a user interacts with a comment posted by poster B. When poster B interacts with user A, then a second directional edge 215 is formed between poster B and user A and the direction of the second directional edge 215 identifies the direction of the interaction, which is from poster B to user A. It should be noted that the algorithm defines a directional edge between a set of posters or between a poster and a user only when there is positive interaction between the set of posters or between the poster and the user. Further interactions between user A and poster B are used to strengthen or weaken the respective directional edges. Once a directional edge is established between a poster and a user, subsequent interactions may be either positive or negative and the edge weight (i.e. association strength) of the directed edge between the two nodes will be adjusted up or down depending on the type and various factors associated with the interaction.

Depending on degree of interactivity of a particular user in specific categories, the algorithm determines an interest vector for the user. The interest vector may be used by an ad placement module to target specific advertisement or promotional media content to the user during the user's interaction. Interest vector, in one embodiment, may be defined as a function of various factors of one or more user interactions with emphasis placed on at least the content of the interaction, geo-location of the user, temporal aspect. In one embodiment, the ad placement module may be integrated with the algorithm and may use the context of user interaction to identify an appropriate promotional media content from a corresponding segment can be rendered alongside the article and comments and interactions of various posters.

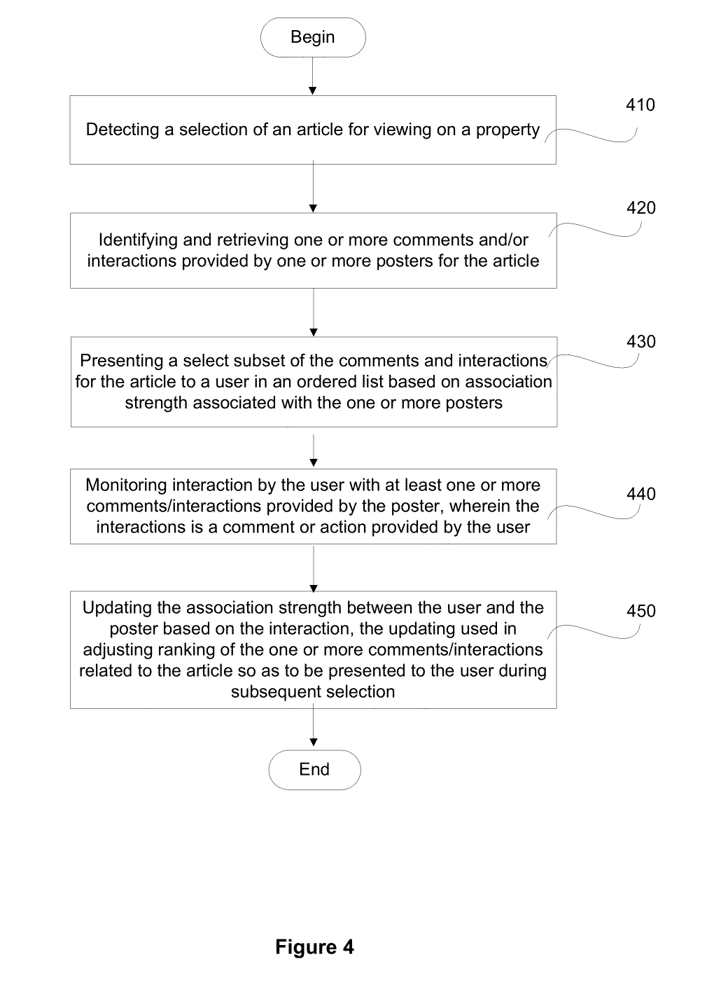

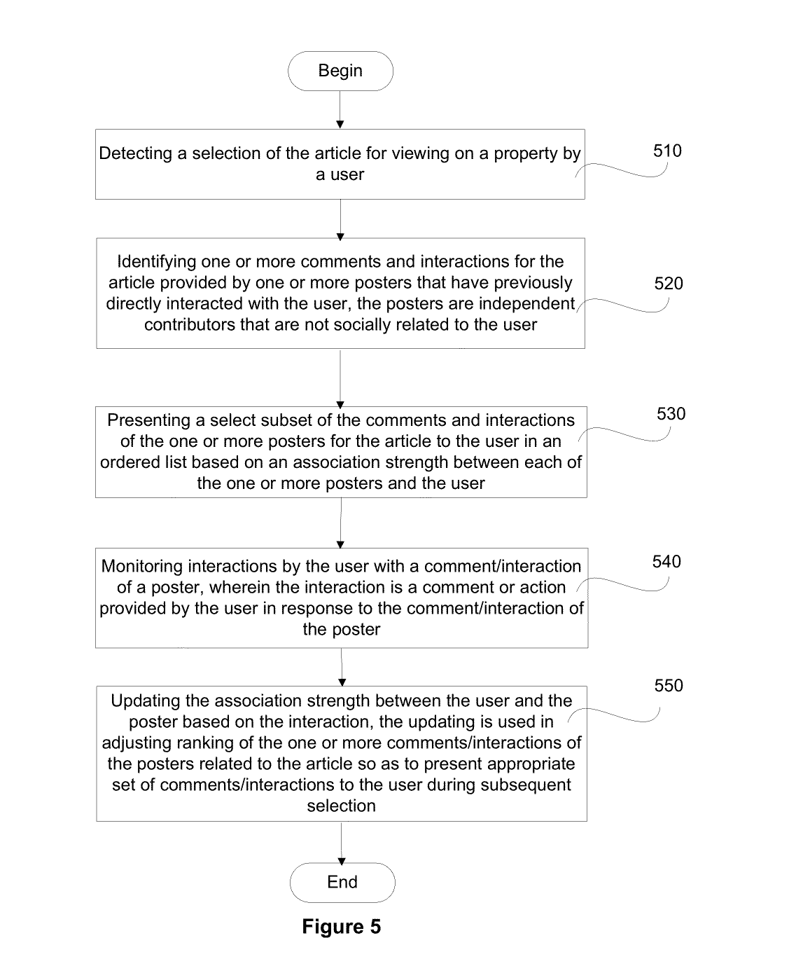

With the general understanding of the various embodiments, methods for allowing user interaction related to an article on an internet property will now be described with reference to FIGS. 4 and 5. As illustrated in FIG. 4, the method begins at operation 410 when an article is selected for viewing by a user. The article may be one of many articles rendered on the internet property, such as a website of a content or service provider. The article may be a news article related to a Sports or Finance or Entertainment category on a Yahoo! News website. An algorithm running on a server will receive the selection of the article by the user and retrieve content for the article from a related content provider. In addition to the content, the algorithm will search one or more databases and retrieve one or more comments and/or interactions provided by one or more posters for the article, as illustrated in operation 420. When no comments/interactions are available for the specific article, the algorithm will identify and retrieve comments and/or interactions provided by posters to other articles but that are related to the context of the article. It should be noted that the posters are independent contributors and do not have any social relation to the user. The algorithm then selects a subset of the comments and/or interactions retrieved from one or more databases, ranks the comments/interactions based on one or more factors associated with the comments/interactions, generates an ordered list of comments/interactions based on the relative ranking and presents the ordered list of comments/interactions along with the content of the article to the user, in response to the selection of the article on the internet property, as illustrated in operation 430. The algorithm then monitors interactions by the user with at least one comment/interaction by a poster, as illustrated in operation 440. The interactions may be a comment or another interaction by the user for the comment/interaction of the poster. Any and all interactions between the user and the one or more comments/interactions of one or more posters are gathered and these interactions are used to update association strengths between the user and each one of the posters based on the respective interactions, as illustrated in operation 450. The interactions could be of different types. As a result, the algorithm attributes corresponding weighted effect on association strength between the two posters. The updated association strength is used to refine the ranking of the one or more comments and interactions retrieved and presented in the ordered list when the same article is selected for subsequent viewing.

FIG. 5 illustrates a method for allowing user interaction related to an article on an internet property, in an alternate embodiment of the invention. The method begins at operation 510, when an algorithm on the server detects selection of an article by a user for viewing on the client. The selection is forwarded by the client through a client-user interface to a server through the server user-interface over the network. The algorithm identifies the content of the article and one or more comments and interactions related to the article provided by one or more posters that have previously directly interacted with the user, as illustrated in operation 520. The posters are independent contributors that do not have any known social relation to the user. A select subset of the comments and interactions of the one or more posters are selected and presented to the user in an ordered list based on the association strength of each one of the posters and the user, as illustrated in operation 530. Every time the user interacts with a poster or vice versa, the association strength between the user and the poster is updated to define the interaction relevance of the poster to the user. A directed graph is generated for each user to identify the user's interaction with one or more posters. It should be noted that the various embodiments of the invention have been described using an overly simplified single user directed graph to provide a clear understanding of the invention. In reality, the directed graph is a more complicated and massive graph with edges capturing the interactions of various users. This massive directed graph includes nodes representing the user and posters that are interacting with each other and an edge between two nodes representing the association strength between any two posters and between the user and each of the posters that has directly interacted with the user. The association strength is computed for each set of posters and between each of the posters and the user based on the type of interaction and other factors associated with the interaction. This directed graph is used to identify the direction of the interaction and the association strength of the interaction between each of the posters and the user based on the type of interaction and the direction of the interaction.

Upon presenting the comments and interactions to the user, the user's interaction with one or more comments/interactions is monitored, as illustrated in operation 540. The user interaction may be a comment or an interaction. The method concludes with the updating of the association strength between the user and the poster based on the monitored interactions of the user, as illustrated in operation 550. The updating of the association strength may result in adjusting the ranking of the one or more comments and interactions of one or more posters and may also result in severing interaction connection between a poster and the user. The adjusted ranking of the comments/interactions of the one or more posters is used when selecting the comments/interactions for the article during subsequent selection by the user.

The present invention provides a tool for a user to tap into the rich and diverse community of internet users with varying degree of knowledge on specific categories and allow the user to have rich and meaningful communication with one or more posters. The posters are not socially related to the user. As a result their interactions may or may not align with the user's own viewpoints. Some of the articles on the internet property may invite comments/interactions from posters that may easily exceed 50,000 to 100,000, depending on the popularity of the article on the message board (or interaction forum) of the internet property. When all the comments/interactions are presented to a user when the user selected the article, the user may get overwhelmed by the sheer number of comments. Additionally, these comments/interactions are not organized in any way and the user may not be familiar with the posters. The tool addresses the aforementioned issue with overwhelming comments/interactions by filtering the comments/interactions to provide a small, focused and manageable number of comments/interactions from a small subset of posters based on the interaction relevance of the posters to a user so that the user can have meaningful and enriching communication with the subset of posters on the article. The algorithm also provides ways to provide enumerated sentiments in the interaction (e.g., “high 5”, “throw a tomato”, “throw an egg”, etc.) between the posters and between a poster and a user and weighing the interactions based on the type of interaction and computing the association strength between the posters/poster and the user taking into consideration the relative weight of the interactions. The algorithm also provides a way to provide users with comments/interactions related to particular categories by tracking the user's interest in specific categories based on his interactions. For instance, if user A interacts heavily with lots of posters in Sports and Politics category, it can be established that user A is really into Sports and Politics. As a result, when the user A logs onto the internet property, the articles related to Sports and Politics may be presented on the user's front page so that he can read and interact with these articles.

It will be obvious, however, to one skilled in the art, that the present invention may be practiced without some or all of these specific details. In other instances, well known process operations have not been described in detail in order not to unnecessarily obscure the present invention.

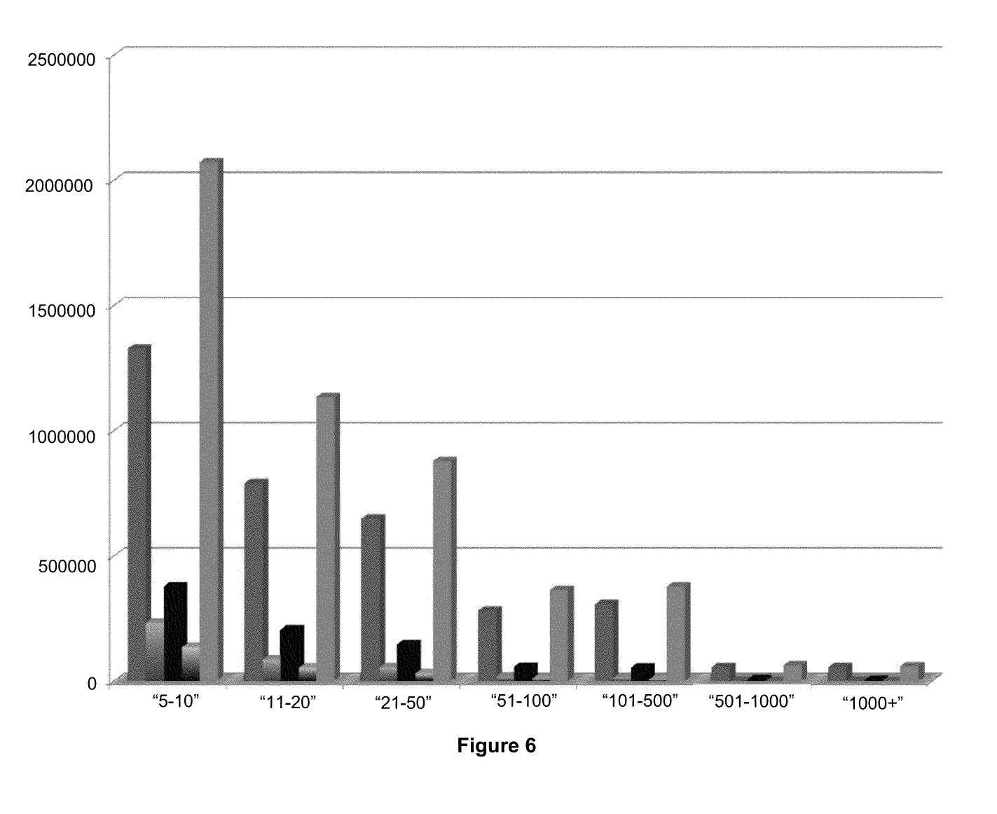

FIG. 6 illustrates a graph identifying the number of interactions between posters that may be affected by the interaction relevance graph of the present invention, in one embodiment of the invention. The graph identifies the number of interactions that each poster has with other posters segmented by regions, such as U.S. east coast, U.S. west coast, Europe, India and the overall number of posters interacting with one another. For instance, as illustrated in the graph, about 2 million users have about 5 to 10 interactions with about 1.35 million of users from U.S. east coast, about 0.35 million from Europe, about 0.2 million from U.S. west coast and about 0.1 million from India. Similarly, about 1.1 million users have about 11-20 interactions with about 0.8 million from U.S. east coast, 0.25 from Europe, 0.125 from U.S. west coast and the remaining from India region. These interactions are obtained from regional data center farms. The algorithm of the current invention provides a tool that enables these users in having a meaningful and focused discussion in the message board by identifying a select subset of the posters that the user often interacts with or whose viewpoints match the user's viewpoints and allows the users to interact with the select subset of comments/interactions by the select subset of posters so as to have enriching and meaningful conversations with posters that are not socially related to the user and may be geographically dispersed across a wide area.

In one embodiment, a system for allowing user interaction to an article on an internet property comprises a client equipped with an user interface for receiving a user selection of the article, transmitting the user selection and for presenting one or more comments and interactions from a plurality of users related to the article. The system also includes a system equipped with a communication interface to receive user selection of the article from the client and to transmit select subset of comments and interactions from one or more posters in response to the user selection, a memory module to store comments and interactions from the one or more posters, and a processor equipped with an algorithm that is configured to, detect a selection of the article for viewing by the user; identify one or more comments and interactions for the article provided by the one or more posters, wherein the posters are independent contributors that are not related to the user; rank the comments and interactions for the article to the user into an ordered list based on an association strength of each of the one or more posters; transmit a select subset of the comments and interactions in the ordered list to the client in response to the selection of the article by the user; monitor interactions by the user with one or more comments or interactions of one or more posters presented in the ordered list; and generate a directed graph with directed edges connecting the user and each of the posters when the monitored interactions by the user are positive type of interactions, the directed edges defining association strength between the user and each of the posters based on the interactions, the directed graph used in identifying interactions for the user during subsequent selection of the article.

In one embodiment, a non-transitory computer readable medium is equipped with an algorithm, which when executed by a server of a computer is configured for allowing user interaction to an article on an internet property, the algorithm comprising programming logic for detecting a selection of the article for viewing by a user; programming logic for retrieving one or more comments and interactions provided by one or more posters for the article, wherein the posters are independent contributors that are not related to the user; programming logic for presenting a select subset of the comments and interactions for the article to the user in an ordered list based on an association strength associated with the one or more posters; programming logic for monitoring interaction by the user with at least one comment or interaction provided by a poster; and programming logic for updating the association strength between the user and the poster based on the interaction, the updating used in adjusting ranking of the one or more comments and interactions presented to the user during subsequent selection.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention could employ various computer-implemented operations involving data stored in computer systems. These operations can include the physical transformations of data, saving of data, and display of data. These operations are those requiring physical manipulation of physical quantities. Usually, though not necessarily, these quantities take the form of electrical or magnetic signals capable of being stored, transferred, combined, compared and otherwise manipulated. Data can also be stored in the network during capture and transmission over a network. The storage can be, for example, at network nodes and memory associated with a server, and other computing devices, including portable devices.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for allowing user interaction related to an article on an internet property, the method implemented by a processor comprising:
detecting a selection of the article on the internet property for viewing by a user;
retrieving one or more comments and interactions provided by one or more posters for the article, wherein the posters are independent contributors without a prior social relationship with the user;
presenting a select subset of the comments and interactions for the article to the user in an ordered list based on an association strength associated with the one or more posters;
monitoring interaction by the user with at least one comment or interaction provided by a poster, the interaction being a comment or action provided by the user in response to the comment or interaction of the poster; and
updating the association strength between the user and the poster based on the interaction, the updating used in adjusting ranking of the one or more comments and interactions presented to the user during subsequent selection.

2. The method of claim 1, wherein retrieving further includes,
retrieving a directed graph related to the posters, the directed graph defined by nodes and edges, wherein the edges capture various interactions between the posters at each end of the edges as related to the article at the internet property; and
identifying a list of comments and interactions between different posters for the article.

3. The method of claim 2, wherein the capturing of the various interactions further includes,
capturing the interactions associated with one or more aliases of each of the posters, wherein the interactions from one or more aliases relate to different articles associated with the internet property.

4. The method of claim 2, wherein updating further includes,
determining if an edge exists between the user and the poster of the comment in the directed graph; and
updating the directed graph based on a type of interaction by the user with the comment or interaction of the poster.

5. The method of claim 1, wherein retrieving further includes,
when the posters provide comments and interactions in more than one category of the internet property,
selecting the interactions of the posters that are of positive type in one or more categories for presenting to the user.

6. The method of claim 5, wherein presenting further includes,
ranking the interactions that are positive type interactions higher when generating the ordered list of interactions for presenting to the user in response to the selection of the article by the user for subsequent viewing.

7. The method of claim 4, wherein updating further includes,
evaluating the type of interaction by the user with the comment or interaction of the poster presented in the ordered list;
when the type of interaction is a positive type interaction and no edge exists between the user and the poster,
forming a directed edge between the user and the poster in the directed graph;
computing the association strength for the directed edge between the user and the poster;
when an edge exists between the user and the poster in the directed graph,
adjusting the association strength at the edge between the user and the poster based on the type of interaction by the user with the comment or interaction of the poster, wherein the type of interaction may be a positive interaction or a negative interaction.

8. The method of claim 4, wherein the type of interaction is determined by,
examining contextual content of the interaction to identify one or more keywords that define the type of interaction; and
establishing the type of interaction based on the identified keywords.

9. The method of claim 7, further includes,
when the association strength between the user and the poster falls below a pre-defined threshold value, removing the edge between the user and the poster.

10. The method of claim 1, further includes,
inserting the comment from a random poster into the ordered list of comments and interactions presented to the user upon subsequent selection of the article for viewing, the comment from the random poster is inserted at a random location within the order list of comments and interactions.

11. The method of claim 2, further includes,
sweeping the directed graph periodically to reduce the association strength between posters at each of the edges by a predefined value, the periodic sweeping results in refining the ordered list of interactions from the one or more posters for presenting to the user,
wherein the sweeping periodically results in any one of breaking of one or more edges, strengthening of one or more edges, or weakening of one or more edges within the directed graph.

12. The method of claim 1, wherein the association strength is computed as a function of one or more factors related to the interaction, wherein each of the one or more factors is accorded a different weight during computation of the association strength and wherein the factors include one or more of positive type of interaction, a level of positive type interaction, negative type of interaction, level of negative type interaction, direct interaction, indirect interaction, distance between the poster and the user, geo-location of the user, geo-location of the poster in relation to the user, temporal attribute, geographical attribute, category of the article, and a count of interactions.

13. A method for allowing user interaction to an article on an internet property, the method implemented by a processor comprising:
detecting a selection of the article for viewing by a user;
identifying one or more comments and interactions for the article provided by one or more posters that have previously interacted with the user, wherein the posters are independent contributors without a prior social relationship with the user and wherein the interactions between the poster and the user are direct interactions;
presenting a select subset of the comments and interactions of the one or more posters for the article to the user in an ordered list based on an association strength between each of the one or more posters and the user;
monitoring interactions by the user with a comment or interaction of a poster, the interaction being a comment or action provided by the user in response to the comment or interaction of the poster; and
updating the association strength between the user and the poster based on the interaction, the updating used in adjusting ranking of the one or more comments and interactions of the posters presented to the user during subsequent selection.

14. The method of claim 13, wherein identifying further includes,
retrieving a directed graph related to the user and the one or more posters, the directed graph defining an edge between the user and each of the one or more posters and between each pair of posters, each of the edges captures accumulated interactions related to the article at the internet property between the user and each of the posters and between each pair of posters and defines association strengths between the pairs of posters and between the posters and the user based on accumulated interactions;
identifying a list of comments and interactions between each of the different posters for the article,
wherein retrieving further includes,
when the user interacts with a plurality of posters,
identifying the interactions between the posters and the user that are of positive type; and
ranking the interactions that are positive type higher when generating the ordered list of interactions for presenting to the user.

15. The method of claim 13, wherein updating further includes,
removing the edge between the user and the poster or between a pair of posters in the directed graph when the association strength between the user and the poster or between the pair of posters falls below a pre-defined threshold.

16. The method of claim 13, further includes,
selecting a comment by a random poster from the interactions between the posters and the user, wherein the comment is related to a category associated with the article, the random poster having had an indirect interaction with the user;
inserting the comment from the random poster into the ordered list of interactions at a random location, such that the random comment is included in the list of interactions presented to the user in response to the selection of the article for viewing.

17. A method for allowing user interaction to an article on an internet property, the method implemented by a processor comprising:
detecting a selection of the article for viewing by a user;
identifying one or more comments and interactions for the article provided by one or more posters, wherein the posters are independent contributors that are not related to the user;
presenting the comments and interactions for the article to the user in an ordered list based on an association strength of each of the one or more posters;
monitoring interaction by the user with a comment or an interaction of a poster presented in the ordered list; and
generating a directed graph with a directed edge connecting the user and the poster when the monitored interaction by the user is a positive type of interaction, the directed edge defining an association strength between the user and the poster based on the interaction, the directed graph used in identifying interactions for the user during subsequent selection of the article.

18. The method of claim 17, wherein monitoring further includes,
tracking interactions by the user with the comments and interactions in the ordered list, the comments and interactions in the ordered list related to a particular category of the article;
determining a degree of interactivity of the user in the particular category associated with the article based on the tracked interactions, the degree of interactivity defining an interest vector for the user;
selecting the comments and interactions from the one or more posters based on the interest vector of the user, the selected comments and interactions presented to the user in the ordered list during subsequent selection of the article; and
targeting a promotional media content related to the article for presenting to the user based on the interest vector, the promotional media content presented to the user alongside the ordered list of comments and interactions from posters for the article.
